(19) United States
(12) Patent Application Publication
(10) Pub. No.: US 2025/0209147 A1
(43) Pub. Date: Jun. 26, 2025

(54) AUTHENTICATION BASED ON MODULATED AUDITORY INPUT

(71) Applicant: Motorola Mobility LLC, Chicago, IL (US)

(72) Inventors: Amit Kumar Agrawal, Bangalore (IN); Himanshu Chug, Bangalore (IN); Satyabrata Rout, Bangalore (IN)

(73) Assignee: Motorola Mobility LLC, Chicago, IL (US)

(21) Appl. No.: 18/391,973

(22) Filed: Dec. 21, 2023

(51) Int. Cl. G06F 21/32

(52) U.S. Cl. CPC G06F 21/32

(57) ABSTRACT

In aspects of authentication based on modulated auditory input, a computing device implements an auditory authentication manager that receives an auditory input as an account access request, such as via a user interface on a mobile device. A voice modulation system of the auditory authentication manager modulates the auditory input to generate a modulated auditory input. The auditory authentication manager can then compare the modulated auditory input to stored modulated voice data, such as generated from an initial auditory input previously received as provided by a user of the mobile device. The auditory authentication manager can authenticate the auditory input for the account access request based at least in part on the comparison of the modulated auditory input to the modulated voice data.

### BACKGROUND

Fraudulent situations occur frequently, such as when software systems are hacked or spammed, leading to sensitive information of users being exposed for potential fraud. Although institutions have applied secure access methods, such as multi-factor authentication, authentication and authorization procedures, encryption, data integrity maintenance techniques, data storage, etc., fraudulent situations still continue to occur placing users' sensitive information at risk.

### BRIEF DESCRIPTION OF THE DRAWINGS

Implementations of the techniques for authentication based on modulated auditory input are described with reference to the following Figures. The same numbers may be used throughout to reference like features and components shown in the Figures.

FIG. 1 illustrates an example system for authentication based on modulated auditory input in accordance with one or more implementations as described herein.

FIG. 2 further illustrates an example of authentication based on modulated auditory input in accordance with one or more implementations as described herein.

FIG. 3 illustrates an example procedure for authentication based on modulated auditory input in accordance with one or more implementations of the techniques described herein.

FIGS. 4 and 5 illustrate example methods for authentication based on modulated auditory input in accordance with one or more implementations of the techniques described herein.

FIG. 6 illustrates various components of an example device that may be used to implement the techniques for authentication based on modulated auditory input as described herein.

### DETAILED DESCRIPTION

Implementations of the techniques for authentication based on modulated auditory input may be implemented as described herein. A computing device, such as any type of a system, network, and/or server device can be implemented to perform aspects of the described techniques for authentication based on modulated auditory input. In one or more implementations, a server device (e.g., a computing device) implements an auditory authentication manager, which can be used to implement aspects of the techniques, such as to generate a voiceprint with a personalized, unique key using voice modulation during authentication enrollment. The auditory authentication manager then provides for subsequent authentication for account access, such as to initiate a banking transaction, for financial communications, for healthcare services, and/or for any other type of confidential account access. Voice biometrics can be critical to ensuring security regarding accessibility in emerging technology. Within various institutions, particularly for financial institutions, when using banking applications, and/or in the healthcare industry, voice biometrics can be utilized to protect sensitive information, such as user information, user account information, and/or any type of personally identifiable information (PII).

Voice biometrics use the characteristics of a person's voice to uniquely identify the person. Similar to a fingerprint of a person's finger or the iris of an eye, a person's voice is unique and voice biometrics can be used as a secure authentication technique to identify a person by their voice characteristics. Protecting a user's biometrics data from hackers and unauthorized usage is needed to maintain the security and integrity of a system, particularly when the biometrics data is used by a person to access financial, banking, healthcare, and/or any other type of sensitive information. In instances where voice biometrics are used, such as to access a user account associated with a business, institution, or service, preventing the use of another person's voice biometrics can be critical for fraud protection, particularly given that a user's voice can be attained in a public setting, or someone can record the user's voice and attempt to spoof an authentication system.

A typical biometric authentication system utilizes a two-step process that involves user enrollment, and then subsequently, user authentication and/or identification. As described herein, a server device implements an auditory authentication manager that includes an enrollment feature via which a person can record an initial auditory input that is stored as auditory data for subsequent comparison and authentication. As an authentication biometric, a voiceprint (also referred to as a voice fingerprint) includes a multitude of voice characteristics. A person's voiceprint can then be used for seamless authentication and identification, such for financial communications and during banking transactions. However, given that a person's voice may be recorded in any number of private settings and/or when exposed in public, a fraudster may attempt to eavesdrop a person's conversation and record his or her voice, such as when engaged in a financial communication or during a banking transaction.

In aspects of the described techniques for authentication based on modulated auditory input, a server device (e.g., a computing device), such as for a financial or banking institution, or for a healthcare system, implements the auditory authentication manager. In implementations, the auditory authentication manager is a voice biometrics authentication system that can be used to authenticate a user who provides an auditory input as an account access request. The auditory authentication manager receives the auditory input as the account access request, such as via a user interface on a mobile device. A voice modulation system of the auditory authentication manager modulates the auditory input to generate a modulated auditory input. The voice modulation system can change the tone, pitch, and/or other characteristics of the person's voice so that the person is not identifiable simply from their usual voice. For example, a male voice may be altered to sound feminine, or to sound like a child by scaling the pitch of the person's usual voice.

The auditory authentication manager can then compare the modulated auditory input to stored modulated voice data, such as generated from an initial auditory input previously received as provided by a user of the mobile device. An enrollment feature of the voice biometrics authentication system includes recording, via the user interface on the mobile device, the initial auditory input that is stored as the modulated voice data. The auditory authentication manager can generate a unique key, and modulate voice characteristics of the initial auditory input and subsequent auditory inputs according to the unique key. The unique key can be generated and applied over the modulated voice content, and the unique key can be encrypted and maintained within the server system that performs the authentication of user access to a user account.

Accordingly, and even though a person speaks in his or her usual voice, the auditory input routes through the voice modulation system, which modulates the voice content, and the unique key is applied to secure the modulated voice content. This allows the person to speak in public without any concern that their usual voice will be copied, recorded, or otherwise compromised for fraudulent use in a voice biometrics authentication system. The auditory authentication manager can then authenticate the auditory input for the account access request based on the comparison of the modulated auditory input to the modulated voice data. With implementation of modulated voice biometrics, a unique key, and encryption, a user's sensitive information will be shielded from security threats and remain safely within the user's account and control.

While features and concepts of the described techniques for authentication based on modulated auditory input is implemented in any number of different devices, systems, environments, and/or configurations, implementations of the techniques for authentication based on modulated auditory input are described in the context of the following example devices, systems, and methods.

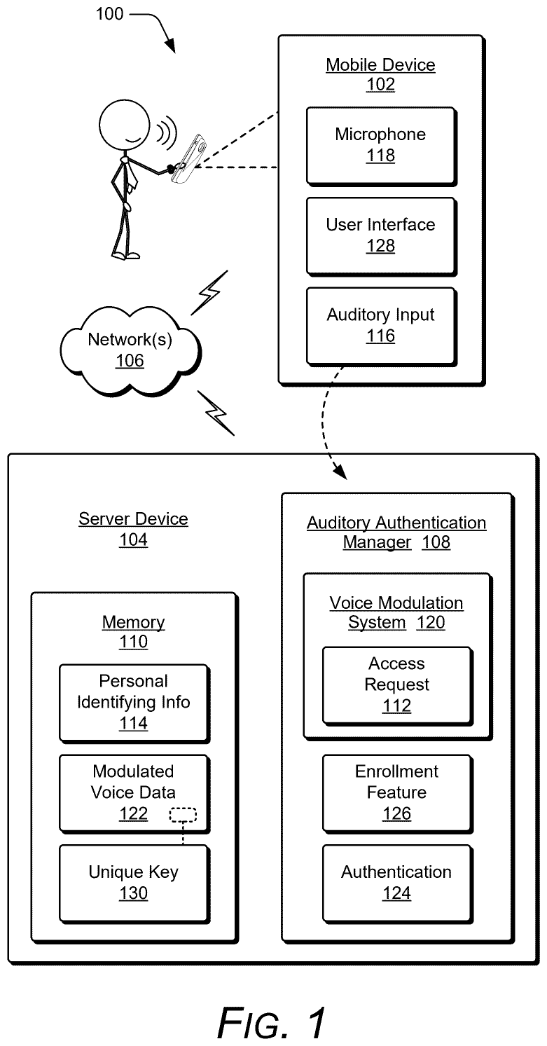

FIG. 1 illustrates an example system 100 for authentication based on modulated auditory input, as described herein. In this example system 100, a mobile device 102 of a user communicates a user access request to a server device 104 (e.g., a computing device) via a communication network 106. For example, a user of the mobile device 102 may initiate an access request to access a user account, obtain personal financial or medical information, or perform a banking transaction. The sensitive information, such as user information, user account information, and/or any type of personally identifiable information (PII) can be stored and accessible from the server devices of an institution where the user has a user account for banking or medical services. Other examples of institutions that maintain user accounts with associated PII include any type of financial, banking, healthcare, travel, and/or any other types of businesses or services that maintain account information and PII associated with a user.

Mobile devices, such as cell phones, tablet devices, smartphones, and similar consumer electronics, are ever-popular and available for use by most anyone in a wide range of environments and for many different applications. As described herein, a user may utilize the mobile device 102 to conduct his or her banking needs, to access and communicate health care information, and/or to access any other type of business and service account. Examples of the mobile device 102 include any type of a wireless device, mobile device, mobile phone, flip phone, client device, companion device, tablet, computing device, communication device, entertainment device, gaming device, media playback device, and/or any other type of computing, consumer, and/or electronic device.

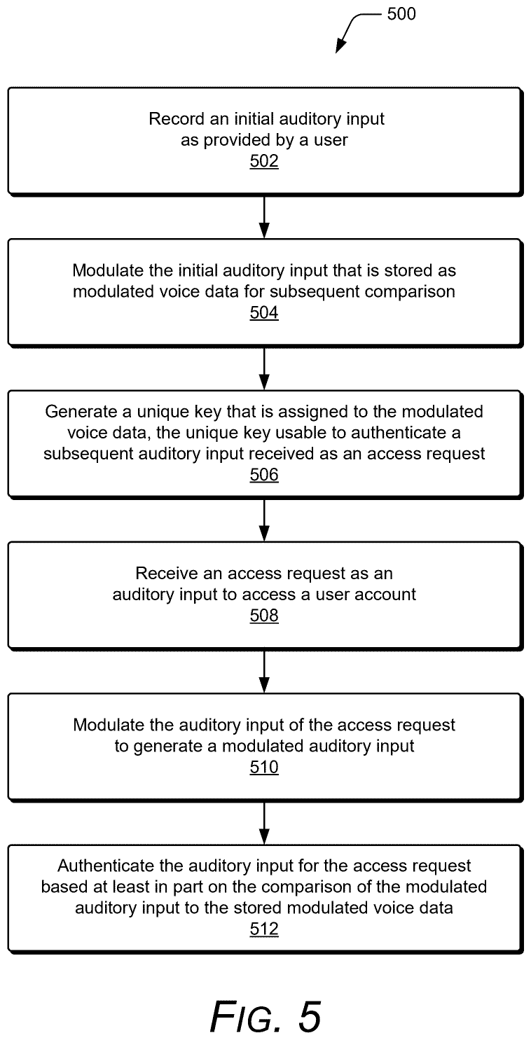

The mobile device 102 can implemented with various components, such as a processor system and memory, as well as any number and combination of different components as further described with reference to the example device shown in FIG. 5. In implementations, the mobile device 102 includes various radios for wireless communication with other devices, such as with the server device 104. For example, the mobile device 102 can include at least one of a Bluetooth (BT) and/or Bluetooth Low Energy (BLE) transceiver, as well as a near field communication (NFC) transceiver. In some cases, the mobile device 102 includes at least one of a WiFi radio, a cellular radio, a global positioning satellite (GPS) radio, and/or any available type of device communication interface. Similarly, the server device 104 is representative of one or more computing devices that may be implemented by an institution or business entity to maintain, manage, and control user account information and PII associated with user accounts. Additionally, the server device 104 may be one or more servers located in a different location than the mobile device 102. The server device 104 can also be implemented with various components, such as a processor system and memory, as well as any number and combination of different components as further described with reference to the example device shown in FIG. 5.

In some implementations, the devices, applications, modules, servers, and/or services described herein communicate via the communication network 106, such as for data communication between the mobile device 102 and the server device 104. The communication network 106 includes a wired and/or a wireless network. The communication network 106 can be implemented using any type of network topology and/or communication protocol, and is represented or otherwise implemented as a combination of two or more networks, to include IP-based networks, cellular networks, and/or the Internet. The communication network 106 can also include mobile operator networks that are managed by a mobile network operator and/or other network operators, such as a communication service provider, mobile phone provider, and/or Internet service provider.

The mobile device 102 and the server device 104 include various functionality that enables implementation of different aspects of authentication based on modulated auditory input, as described herein. The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102.

In this example system 100 for authentication based on modulated auditory input, the server device 104 implements an auditory authentication manager 108 (e.g., as a device application). As shown in this example, the auditory authentication manager 108 represents functionality (e.g., logic, software, and/or hardware) enabling aspects of the described techniques for authentication based on modulated auditory input. The auditory authentication manager 108 can be implemented as computer instructions stored on computer-readable storage media and can be executed by a processor system of the server device 104. Alternatively, or in addition, the auditory authentication manager 108 can be implemented at least partially in hardware of the device.

In one or more implementations, the auditory authentication manager 108 includes independent processing, memory, and/or logic components functioning as a computing and/or electronic device integrated with the server device 104. Alternatively, or in addition, the auditory authentication manager 108 can be implemented in software, in hardware, or as a combination of software and hardware components. In this example, the auditory authentication manager 108 is implemented as a software application or module, such as executable software instructions (e.g., computer-executable instructions) that are executable with a processor system of the server device 104 to implement the techniques and features described herein. As a software application or module, the auditory authentication manager 108 can be stored on computer-readable storage memory (e.g., a memory 110 of the device), or in any other suitable memory device or electronic data storage implemented with the manager. Alternatively or in addition, the auditory authentication manager 108 is implemented in firmware and/or at least partially in computer hardware. For example, at least part of the auditory authentication manager 108 is executable by a computer processor, and/or at least part of the auditory authentication manager is implemented in logic circuitry.

In this example system 100, the auditory authentication manager 108 implemented by the server device 104 can receive an access request 112, such as to access a user account that contains sensitive information of a person who is associated with the user account, such as PII 114 stored at the server device. The PII may include information such as the user's name, address, social security number, email address, phone number, financial account numbers, medical information, and any other type of personal or sensitive information corresponding to a person. A server device of a financial or banking institution may receive a request to access account balances and/or credit card information. Similarly, a server device of a healthcare provider may receive a request to access medical records and/or insurance information. A user can initiate the access request 112 as an auditory input 116 at the mobile device 102 of the user. In this example, the mobile device 102 includes a microphone 118 as an input device to capture the auditory input 116 of the user. As described above, the context of the auditory input 116 from the user may be associated with any type of user account access in a financial context, a banking context, a healthcare context, a travel context, and/or in any other type of service or information context.

In this example implementation, the auditory authentication manager 108 includes a voice modulation system 120 that receives the access request 112 (e.g., as the auditory input 116 communicated from the mobile device 102) and the voice modulation system modulates the auditory input to generate a modulated auditory input. The voice modulation system 120 can change the tone, pitch, and/or other characteristics of the person's voice so that the user is not identifiable simply from their usual voice. For example, a male voice may be altered to sound feminine, or to sound like a child by scaling the pitch of the user's usual voice. In implementations, the voice modulation system 120 can alter, transform, and/or modulate input audio (e.g., voice content as the auditory input) and change voice tone and pitch.

The auditory authentication manager 108 can then compare the modulated auditory input to stored modulated voice data 122, and then provide or perform authentication 124 of the auditory input based on the comparison of the modulated auditory input to the modulated voice data 122. In implementations, the auditory authentication manager 108 is a biometric authentication system configured to authenticate the user who provides the auditory input 116, such as to authenticate the user for access to his or her user account that contains the sensitive and/or personal information. The modulated voice data 122 can be generated from an initial auditory input previously received as provided by the user of the mobile device.

In this example, an enrollment feature 126 of the auditory authentication manager 108 (e.g., a voice biometrics authentication system) is implemented to record, via the user interface 128 on the mobile device 102, the initial auditory input that is modulated by the voice modulation system 120 and stored as the modulated voice data 122. The modulated voice data 122 can be based on an initial auditory input previously received at the server device 104 by the auditory authentication manager 108, such as provided by the user of the mobile device. The modulated voice data 122 is a modulated recording of the user's original voice, modulating any number of voice characteristics, such as cadence, tone, language, accent, etc. which are captured, modulated, and stored as the modulated voice data.

In implementations, the auditory authentication manager 108 can also generate and assign a unique key 130 to the modulated voice data 122. The auditory authentication manager 108 can apply the unique key 130 to modulate the voice characteristics of the initial auditory input and subsequent auditory inputs according to the unique key. The unique key 130 can be generated and applied over the modulated voice content, and the unique key can be encrypted and maintained within the server system or device that performs the authentication for requested user access to a user account. The unique key 130 can be encrypted and stored in the device memory 110. In implementations, the auditory authentication manager 108 can authenticate the auditory input 116 of the access request 112 based on the unique key 130 and/or based on the context of the auditory input as associated with the PII 114 that corresponds to the user who provides the auditory input. The authentication 124 can include receiving the access request 112 as the auditory input 116 of the user to access his or her account information, and the auditory authentication manager 108 modulates and compares the modulated auditory input as the user's voice from the access request to the stored modulated voice data 122 with the unique key 130 applied.

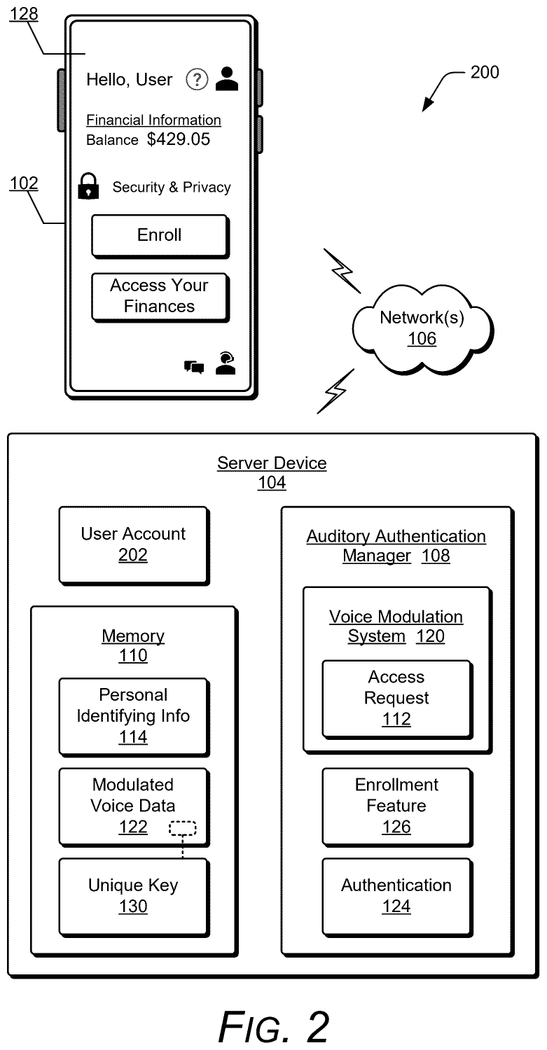

FIG. 2 further illustrates an example 200 of authentication based on modulated auditory input, as described herein. In this example 200, the mobile device 102 of the user has a display device to display the user interface 128, such as a device application user interface associated with accessing a user account 202 associated with any type of an institution where the user has a user account for banking or medical services. Other examples of institutions that maintain user accounts include any type of financial, banking, healthcare, travel, and/or other types of businesses or services that maintain account information associated with a user. In this example, the user has initiated the access request 112 via the mobile device 102, which is received by the auditory authentication manager 108 at the server device 104 via the communication network 106. Once authenticated, the requested information (e.g., financial information in this example) is communicated back from the server device 104 to the mobile device 102, and the requested information is displayed in the user interface 128 on the mobile device. Additionally, the user interface 128 may display one or more selectable controls that are selectable by the user, such as to initiate the enrollment feature 126, as described above with reference to FIG. 1.

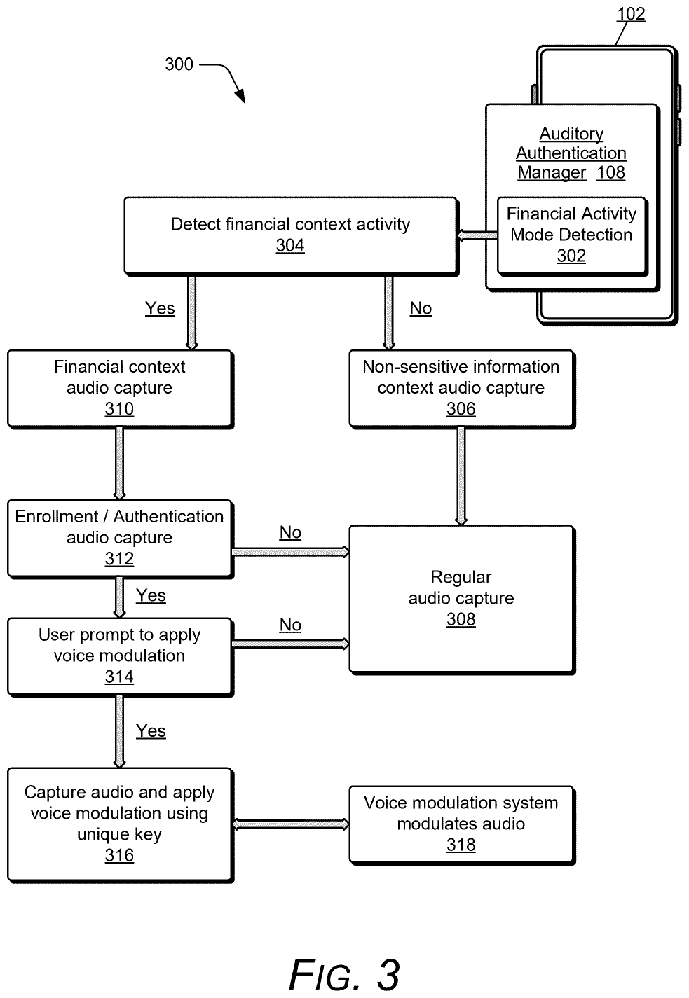

FIG. 3 illustrates an example procedure 300 that can be implemented by the example system 100 as shown and described with reference to FIG. 1 for authentication based on modulated auditory input, as described herein. In this example, the mobile device 102 includes a feature of the auditory authentication manager 108 for financial activity mode detection 302, which may be implemented as any type of device application. For example, the mode detection can determine that a financial or banking application is executing on the mobile device run as a foreground application. In implementations, the mode detection 302 can detect financial context activity in a voice input to the mobile device by a user of the device (at 304). The auditory authentication manager 108 can determine a financial context or non-financial context (e.g., a non-sensitive information context) based on the metadata that is available with each application activity running in the foreground on the device. The metadata or application category may also be available in an application description.

If the voice input to the mobile device 102 (e.g., the auditory input 116) does not have a financial context (i.e., “No” from 304), then the voice input can be captured as having a non-sensitive information context (at 306) and regular audio capture on the device (at 308). If however, the voice input to the mobile device 102 (e.g., the auditory input 116) does have a financial context (i.e., “Yes” from 304), then the voice input can be captured for financial context (at 310), such as for enrollment or authentication audio capture (at 312). In implementations, the user of the mobile device 102 can be prompted to apply voice modulation (at 314). The addition of a voice modulation key (e.g., the unique key 130) can be applied based on user consent as a setting. If the user declines to apply voice modulation (i.e., “No” from 314), then the voice input is regular audio capture on the device (at 308). If however, the user consents to apply the voice modulation (i.e., “Yes” from 314), then the audio of the voice input is captured (at 316), and the voice modulation system 120 modulates the voice input using the unique key 130 (at 318).

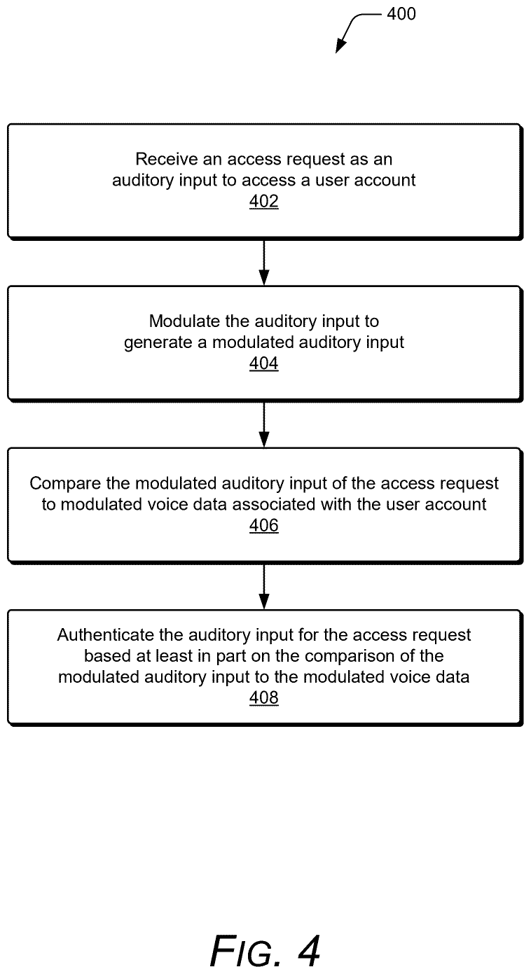

Example methods 400 and 500 are described with reference to respective FIGS. 4 and 5 in accordance with one or more implementations of authentication based on modulated auditory input, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 for authentication based on modulated auditory input. The order in which the method is described is not intended to be construed as a limitation, and any number or combination of the described method operations may be performed in any order to perform a method, or an alternate method.

At 402, an access request is received as an auditory input to access a user account. For example, the auditory authentication manager 108 implemented by the server device 104 (e.g., a computing device) receives the auditory input 116 as the access request 112, such as a voice input request by a user of the mobile device 102 to access personal account information at a financial, banking, or healthcare business or service. At 404, the auditory input of the access request is modulated to generate a modulated auditory input. For example, the voice modulation system 120 of the auditory authentication manager 108 modulates the auditory input 116 of the access request 112 to generate a modulated auditory input.

At 406, the modulated auditory input of the access request is compared to modulated voice data associated with the user account. For example, the auditory authentication manager 108 compares the modulated auditory input of the access request 112 to the stored modulated voice data 122. The modulated voice data 122 can be based on an initial auditory input previously received at the server device 104 by the auditory authentication manager 108, such as provided by the user of the mobile device 102. The modulated voice data 122 is a modulated recording of the user's original voice, modulating any number of voice characteristics, such as cadence, tone, language, accent, etc. which are captured, modulated, and stored as the modulated voice data. The server device 104 stores the modulated voice data 122, as well as the personally identifiable information 114 and/or other sensitive information associated with the user and the modulated voice data.

At 408, the auditory input for the access request is authenticated based at least in part on the comparison of the modulated auditory input to the modulated voice data. For example, the auditory authentication manager 108 authenticates the auditory input 116 for the access request 112 based on the comparison of the modulated auditory data to the modulated voice data 122. In implementations, the auditory authentication manager 108 is a voice biometrics authentication system that can authenticate a user who provides the auditory input 116 as the access request 112. The enrollment feature 126 of the voice biometric authentication system includes recording, via the user interface 128 on the mobile device 102, an initial auditory input that is modulated and stored as the modulated voice data 122 in the memory 110 of the server device (or other connected or accessible memory). The auditory authentication manager 108 can also generate and assign a unique key 130 to the modulated voice data 122. The auditory authentication manager 108 can apply the unique key 130 to modulate the voice characteristics of the initial auditory input and subsequent auditory inputs according to the unique key. The unique key 130 can be generated and applied over the modulated voice content, and the unique key can be encrypted and maintained within the server system or device that performs the authentication for requested user access to a user account. A context of the auditory input can be one of a financial context, a banking context, a healthcare context, a travel context, and/or any other type of context where a user may seek to access a user account.

FIG. 5 illustrates example method(s) 500 for authentication based on modulated auditory input. The order in which the method is described is not intended to be construed as a limitation, and any number or combination of the described method operations may be performed in any order to perform a method, or an alternate method.

At 502, an initial auditory input is recorded as provided by a user. For example, the auditory authentication manager 108 implemented by the server device 104 (e.g., a computing device) receives an initial auditory input. The auditory authentication manager 108 includes the enrollment feature 126 to record, via the user interface 128 on the mobile device 102, an initial auditory input that is modulated and stored as the modulated voice data 122 in the memory 110 of the server device (or other connected or accessible memory). The modulated voice data 122 can be based on an initial auditory input previously received at the server device 104 by the auditory authentication manager 108, such as provided by the user of the mobile device.

At 504, the initial auditory input is modulated and stored as modulated voice data for subsequent comparison. For example, the voice modulation system 120 of the auditory authentication manager 108 modulates an initial auditory input that is stored as the modulated voice data 122. The modulated voice data 122 is a modulated recording of the user's original voice, modulating any number of voice characteristics, such as cadence, tone, language, accent, etc. which are captured, modulated, and stored as the modulated voice data.

At 506, a unique key is generated and assigned to the modulated voice data, the unique key usable to authenticate a subsequent auditory input received as an access request. For example, the auditory authentication manager 108 generates and assigns a unique key 130 to the modulated voice data 122, and the unique key 130 is usable by the auditory authentication manager 108 to authenticate the auditory input 116 received as the access request 112. The auditory authentication manager 108 can apply the unique key 130 to modulate the voice characteristics of the initial auditory input and subsequent auditory inputs according to the unique key. The unique key 130 can be generated and applied over the modulated voice content, and the unique key can be encrypted and maintained within the server system or device that performs the authentication for requested user access to a user account.

At 508, an access request is received as an auditory input to access a user account. For example, the auditory authentication manager 108 implemented by the server device 104 (e.g., a computing device) receives the auditory input 116 as the access request 112, such as a voice input request by a user of the mobile device 102 to access personal account information at a financial, banking, or healthcare business or service. At 510, the auditory input of the access request is modulated to generate a modulated auditory input. For example, the voice modulation system 120 of the auditory authentication manager 108 modulates the auditory input 116 of the access request 112 to generate a modulated auditory input for comparison of the auditory input 116 to the modulated voice data 122.

At 512, the auditory input for the access request is authenticated based at least in part on the comparison of the modulated auditory input to the stored modulated voice data. For example, the auditory authentication manager 108 authenticates the auditory input 116 for the access request 112 based on the comparison of the modulated auditory data to the modulated voice data 122. In implementations, the auditory authentication manager 108 is a voice biometrics authentication system that can authenticate a user who provides the auditory input 116 as the access request 112.

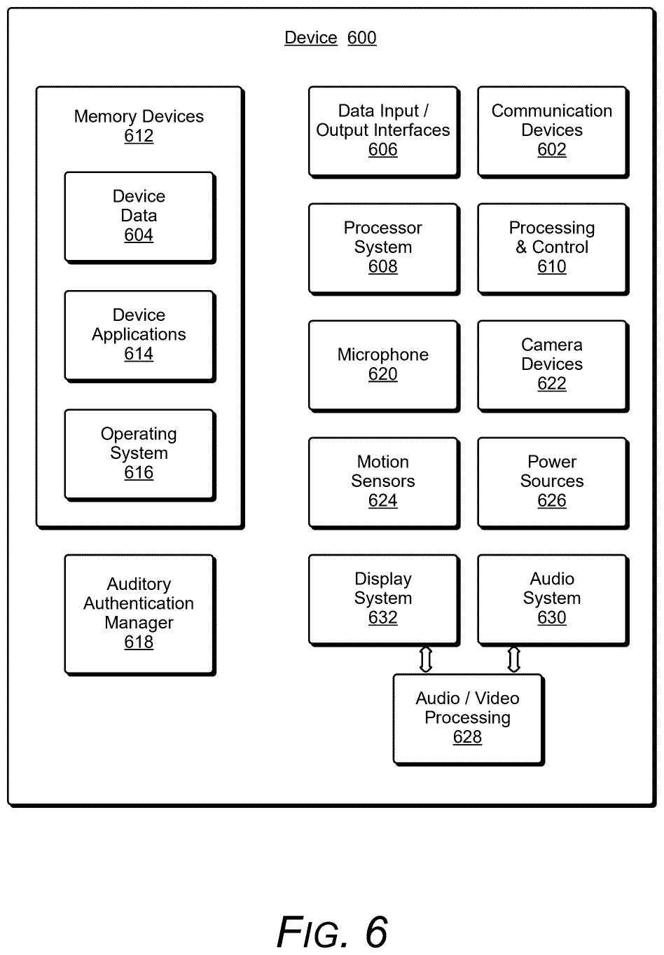

FIG. 6 illustrates various components of an example device 600, which can implement aspects of the techniques and features for authentication based on modulated auditory input, as described herein. The example device 600 may be implemented as any of the devices described with reference to the previous FIGS. 1-5, such as any type of a computing device, server device, wireless device, mobile device, mobile phone, flip phone, client device, companion device, display device, tablet, communication, entertainment, gaming, media playback, and/or any other type of computing, consumer, and/or electronic device. For example, the mobile device 102 and/or the server device 104 (e.g., a computing device) described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes an auditory authentication manager 618 that implements various aspects of the described features and techniques described herein. The auditory authentication manager 618 may be implemented with hardware components and/or in software as one of the device applications 614, such as when the example device 600 is implemented as the mobile device 102 and/or the server device 104 (e.g., a computing device) as described with reference to FIGS. 1-5. An example of the auditory authentication manager 618 is the auditory authentication manager 108 implemented by the server device 104, such as a software application and/or as hardware components in the computing device. In implementations, the auditory authentication manager 618 may include independent processing, memory, and logic components as a computing and/or electronic device integrated with the example device 600.

The example device 600 can also include a microphone 620 (e.g., to capture an audio input of a user) and/or camera devices 622 (e.g., to capture video and/or digital images), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for authentication based on modulated auditory input have been described in language specific to features and/or methods, the appended claims are not necessarily limited to the specific features or methods described. Rather, the specific features and methods are disclosed as example implementations for authentication based on modulated auditory input, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A computing device, comprising: a memory to store modulated voice data, and an auditory authentication manager implemented at least partially in hardware and configured to cause the computing device to: modulate an auditory input received as an account access request to generate a modulated auditory input; compare the modulated auditory input to the stored modulated voice data; and authenticate the auditory input for the account access request based at least in part on comparison of the modulated auditory input to the modulated voice data.

Alternatively, or in addition to the above-described computing device, any one or combination of: the auditory authentication manager is a voice biometrics authentication system configured to authenticate a user who provides the auditory input as the account access request; and the modulated voice data is based on an initial auditory input previously received as provided by the user. The memory is configured to store personally identifiable information associated with the user and the modulated voice data. An enrollment feature of the voice biometrics authentication system includes recording, via a user interface on a mobile device, the initial auditory input that is stored as the modulated voice data. The modulated voice data is assigned a unique key usable by the auditory authentication manager to authenticate the auditory input for the account access request. The auditory authentication manager is configured to generate the unique key; and modulate voice characteristics of the auditory input according to the unique key. The auditory authentication manager is configured to authenticate the auditory input for the account access request based at least in part on a context of the auditory input as associated with personally identifiable information associated with a user who provides the auditory input, the context of the auditory input being at least one of a financial context, a banking context, or a healthcare context.

A method, comprising: receiving an access request as an auditory input to access a user account; modulating the auditory input to generate a modulated auditory input; comparing the modulated auditory input of the access request to modulated voice data associated with the user account; and authenticating the auditory input for the access request based at least in part on comparison of the modulated auditory input to the modulated voice data.

Alternatively, or in addition to the above-described method, any one or combination of: the method further comprising recording an initial auditory input as provided by a user prior to the access request; and modulating the initial auditory input that is stored as the modulated voice data for subsequent comparison. The authenticating the auditory input for the access request includes authenticating the user who provides the auditory input of the access request. The method further comprising assigning a unique key to the modulated voice data, the unique key usable to authenticate the auditory input of the access request. The method further comprising generating the unique key; and modulating voice characteristics of the auditory input according to the unique key. The authenticating the auditory input for the access request is based at least in part on a context of the auditory input as associated with personally identifiable information associated with a user who provides the auditory input.

A system, comprising: a processor coupled with a memory that stores modulated voice data and a unique key applied to generate the modulated voice data; and an auditory authentication manager implemented at least partially by the processor and configured to: receive an access request as an auditory input to access a user account that includes at least one of personally identifiable information or confidential user information; modulate the auditory input of the access request to generate a modulated auditory input; and authenticate the auditory input for the access request based at least in part on comparison of the modulated auditory input to the stored modulated voice data.

Alternatively, or in addition to the above-described system, any one or combination of: the auditory authentication manager is configured to authenticate a user who provides the auditory input as the access request; and the modulated voice data is based on an initial auditory input previously received as provided by the user. The access request is received via a user interface on a mobile device of the user. An enrollment feature of the auditory authentication manager includes recording, via the user interface on the mobile device, the initial auditory input that is the stored modulated voice data. The modulated voice data is assigned the unique key usable by the auditory authentication manager to authenticate the auditory input for the access request. The auditory authentication manager is configured to generate the unique key; and modulate voice characteristics of the auditory input according to the unique key. The auditory authentication manager is configured to authenticate the auditory input for the access request based at least in part on a context of the auditory input as associated with at least one of the personally identifiable information or the confidential user information associated with the user account.

1. A computing device, comprising:
a memory to store modulated voice data; and
an auditory authentication manager implemented at least partially in hardware and configured to cause the computing device to:
modulate an auditory input received as an account access request to generate a modulated auditory input;
compare the modulated auditory input to the stored modulated voice data; and
authenticate the auditory input for the account access request based at least in part on comparison of the modulated auditory input to the modulated voice data.

2. The computing device of claim 1, wherein:
the auditory authentication manager is a voice biometrics authentication system configured to authenticate a user who provides the auditory input as the account access request; and
the modulated voice data is based on an initial auditory input previously received as provided by the user.

3. The computing device of claim 2, wherein the memory is configured to store personally identifiable information associated with the user and the modulated voice data.

4. The computing device of claim 2, wherein an enrollment feature of the voice biometrics authentication system includes recording, via a user interface on a mobile device, the initial auditory input that is stored as the modulated voice data.

5. The computing device of claim 1, wherein the modulated voice data is assigned a unique key usable by the auditory authentication manager to authenticate the auditory input for the account access request.

6. The computing device of claim 5, wherein the auditory authentication manager is configured to:
generate the unique key; and
modulate voice characteristics of the auditory input according to the unique key.

7. The computing device of claim 1, wherein the auditory authentication manager is configured to authenticate the auditory input for the account access request based at least in part on a context of the auditory input as associated with personally identifiable information associated with a user who provides the auditory input, the context of the auditory input being at least one of a financial context, a banking context, or a healthcare context.

8. A method, comprising:
receiving an access request as an auditory input to access a user account;
modulating the auditory input to generate a modulated auditory input;
comparing the modulated auditory input of the access request to modulated voice data associated with the user account; and
authenticating the auditory input for the access request based at least in part on comparison of the modulated auditory input to the modulated voice data.

9. The method of claim 8, further comprising:
recording an initial auditory input as provided by a user prior to the access request; and
modulating the initial auditory input that is stored as the modulated voice data for subsequent comparison.

10. The method of claim 9, wherein the authenticating the auditory input for the access request includes authenticating the user who provides the auditory input of the access request.

11. The method of claim 8, further comprising:
assigning a unique key to the modulated voice data, the unique key usable to authenticate the auditory input of the access request.

12. The method of claim 11, further comprising:
generating the unique key; and
modulating voice characteristics of the auditory input according to the unique key.

13. The method of claim 8, wherein the authenticating the auditory input for the access request is based at least in part on a context of the auditory input as associated with personally identifiable information associated with a user who provides the auditory input.

14. A system, comprising:
a processor coupled with a memory that stores modulated voice data and a unique key applied to generate the modulated voice data; and
an auditory authentication manager implemented at least partially by the processor and configured to:
receive an access request as an auditory input to access a user account that includes at least one of personally identifiable information or confidential user information;
modulate the auditory input of the access request to generate a modulated auditory input; and
authenticate the auditory input for the access request based at least in part on comparison of the modulated auditory input to the stored modulated voice data.

15. The system of claim 14, wherein:
the auditory authentication manager is configured to authenticate a user who provides the auditory input as the access request; and
the modulated voice data is based on an initial auditory input previously received as provided by the user.

16. The system of claim 15, wherein the access request is received via a user interface on a mobile device of the user.

17. The system of claim 16, wherein an enrollment feature of the auditory authentication manager includes recording, via the user interface on the mobile device, the initial auditory input that is the stored modulated voice data.

18. The system of claim 14, wherein the modulated voice data is assigned the unique key usable by the auditory authentication manager to authenticate the auditory input for the access request.

19. The system of claim 18, wherein the auditory authentication manager is configured to:
generate the unique key; and
modulate voice characteristics of the auditory input according to the unique key.

20. The system of claim 19, wherein the auditory authentication manager is configured to authenticate the auditory input for the access request based at least in part on a context of the auditory input as associated with at least one of the personally identifiable information or the confidential user information associated with the user account.
